(19) United States
(12) Patent Application Publication
(10) Pub. No.: US 2009/0026982 A1
(43) Pub. Date: Jan. 29, 2009

(54) Structure for LED lamp and method for forming the improved structure

(75) Inventors: George Lee, Chino, CA (US); Arthur Young, Chino, CA (US)

Correspondence Address: BIRCH STEWART KOLASCH & BIRCH, PO BOX 747, FALLS CHURCH, VA, 22040-0747, US

(73) Assignee: AMERICAN BRIGHT LIGHTING, INC.

(21) Appl. No.: 11/878,414

(22) Filed: Jul. 24, 2007

(51) Int. Cl. H05B 37/00; H01J 9/00

(52) U.S. Cl. 315/312; 445/23

(57) ABSTRACT

The present invention generally relates to an improved structure for an LED lamp and a method for forming the improved structure, more particularly to an improved LED lamp structure having a special figure so as to replace a traditional incandescent light bulb. The improved structure for the LED lamp is disclosed and comprises: a flexible PCB, which is shaped to form a three-dimensional structure and has at least one tier of LEDs mounted thereon, the LED being electrically connected to the printed circuits of the flexible PCB; and a rectifier, which is disposed on the end of the three-dimensional member and electrically connected to the three-dimensional member. The method for forming the improved structure of the LED lamp is disclosed and comprises the steps of: (1) providing a flexible PCB, which can be formed a three-dimensional structure and has a least one tier of LEDs thereon; (2) fabricating the flexible PCB to form the three-dimensional structure; and (3) electrically connecting a rectifier to the three-dimensional structure.

### BACKGROUND OF THE INVENTION

1. Field of the Invention

The present invention generally relates to an improved structure for an LED lamp and a method for forming the improved structure, more particularly to an improved LED lamp structure having a special structure so as to replace a traditional incandescent light bulb.

2. Description of the Prior Art

The field of illumination is more fancy and important than ever due to that of providing light at night, many colors of light creating vision effect, the designs of lamps decorating the environments, etc. Hence, the light industry has gradually taken account during the past several decades, especially LED has being developed within the past 15 years.

With reference to FIGS. 7A, 7B, and 7C, which illustrate a schematic view of a traditional incandescent light bulb, a schematic view of an LED light with LEDs linearly disposed in prior arts, and a schematic view of an LED light with LEDs disposed as a cylindrical member in prior arts. Traditional incandescent light bulb has been used for more than a hundred years. LED is such a revolution improvement to the incandescent light bulb after the developing direction thereof is toward the field of Solid State Lighting. The lifetime of an incandescent light bulb is around 1,000 hours, on the other hand, the lifetime of an LED is at least 50,000 hours and with lower power consumptions. Based on these advantages, incandescent light bulb being replaced with LED is a trend.

There are mainly two parts in traditional incandescent light bulbs, that is, a lamp housing and a filament. Unlike all LED light bulbs developed today, this improved LED light bulb uses flexible PCB, spacer, and holder to form an incandescent light bulb kind of spherical light projection—a must have feature not seen in all other LED lamps.

Hence, this spherical light structure to replace the filament portion in an incandescent light bulb is unique and makes a much better incandescent light bulb replacement.

### SUMMARY OF THE INVENTION

The primary objective of the present invention is to provide an improved structure for an LED lamp. The improved structure is easily made and power saving due to that of adopting LEDs. In other words, a flexible PCB with wheel-spoke structure can mount a plurality of electrical components first and then fold continuously to form a three-dimensional spherical structure, which is shaped as a filament in traditional incandescent light bulb. Present invention is to be applied to incandescent light bulbs of all kinds.

The improved structure for the LED lamp is disclosed and comprises: a flexible PCB, which is wheel-spoke shaped to form a three-dimensional structure and has at least one tier of LEDs mounted thereon, the LEDs is electrically connected to the printed circuits of the flexible PCB; and an electrical mounting member, if needed, which can be used as a rectifier and flexible PCB's soldering pins.

A method for forming the improved structure of the LED lamp is disclosed and comprises the steps of: (1) providing a flexible PCB, which can be wheel-spoke shaped to form a three-dimensional structure and has a least one tier of LEDs thereon; (2) fabricating the flexible PCB to form the three-dimensional structure with a spacer in the center of spherical structure; and (3) electrically connecting the electrical mounting member to the three-dimensional structure.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of a preferred embodiment of an improved structure for a one-tier LED lamp of the present invention;

FIG. 2 illustrates a 3-D view of the preferred embodiment of the improved structure for the LED lamp of the present invention with multiple tiers of LEDs;

FIG. 3 illustrates a schematic exploded view of a one-tier LED flexible PCB of the preferred embodiment of the present invention;

FIG. 4 illustrates steps of a method for forming the improved structure of the LED lamp of the present invention with multiple tiers of LEDs;

FIG. 5 illustrates a schematic view of a sequence of installing the improved structure into a transparent shell of the present invention;

FIG. 6 illustrates a schematic exploded view of a multi-tier LED flexible PCB of a second preferred embodiment of the present invention;

FIG. 7A illustrates a schematic view of a traditional incandescent light bulb;

FIG. 7B illustrates a schematic view of an LED light with LEDs linearly disposed in prior arts; and

FIG. 7C illustrates a schematic view of an LED light with LEDs disposed as a cylindrical member in prior arts.

### DETAILED DESCRIPTION OF THE INVENTION

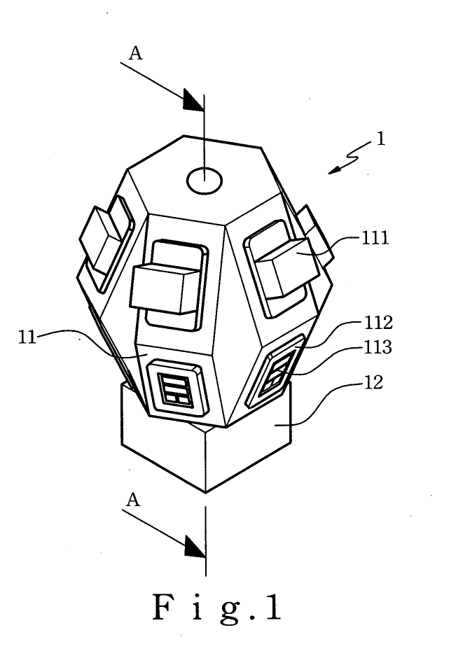

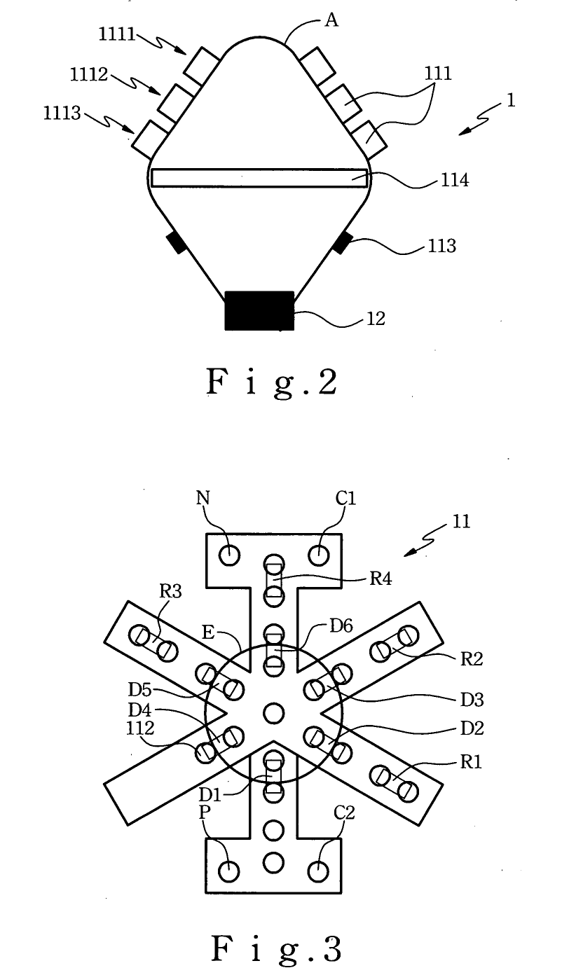

With reference to FIG. 1, which illustrates a schematic view of a preferred embodiment of an improved structure for a one-tier LED lamp of the present invention. The improved structure 1 includes: a flexible PCB 11, which is shaped as the figure of “*” in the preferred embodiment to form a three-dimensional structure A, such as a globe shape, and has a plurality of LEDs 111 mounted thereon, the LEDs 111 are electrically connected to the printed circuits of the flexible PCB 11; a plurality of solder pads 112, which are mounted on the flexible PCB 11; a plurality of resisters 113, which are disposed on the solder pads 112 so as to electrically connect to the flexible PCB 11; and an electrical mounting member 12, which is a bridge rectifier 12 as the preferred embodiment and electrically connected to the end of the three-dimensional structure A; further that, there is a support member 114, as a spacer, in the improved structure for supporting the hollow improved structure horizontally, as shown in FIG. 2, which illustrates a 3-D view of the preferred embodiment of the improved structure for the LED lamp of the present invention with multiple tiers of LEDs. In FIG. 2, there are three tiers of LEDs, which are a 1^{st} tier 1111, a 2^{nd} tier 1112, and a 3^{rd} tier. As a matter of fact, more tiers of LEDs can be added to form a higher wattage lamp.

The flexible PCB can be another figure of “+”, or other types of figures, which are able to form several types of three-dimensional members, such as sphere, cube, rectangular solid, polygon solid, etc.

With reference to FIG. 3, which illustrates a schematic exploded view of the flexible PCB of the preferred embodiment of the present invention. The flexible PCB 11 with *-figure includes: 6 LEDs D1, D2, D3, D4, D5, and D6; 4 resistors R1, R2, R3, and R4; 2 solder pads C1, C2; 1 positive solder pad P for +12V; and 1 negative solder pad N for ground mounted thereon. After mounting all the components on the flexible PCB 11 and folding the flexible PCB 11 to form the three-dimensional member A, the improved structure 1 may be finished by way of electrically connecting the rectifier 12 and the three-dimensional structure A. As shown in FIG. 3, a circle E with a dotted line represents the 1^{st} tier 1111 for LEDs D1, D2, D3, D6, D5, and D4. Similarly more tiers of LEDs can be disposed for variable dimensions.

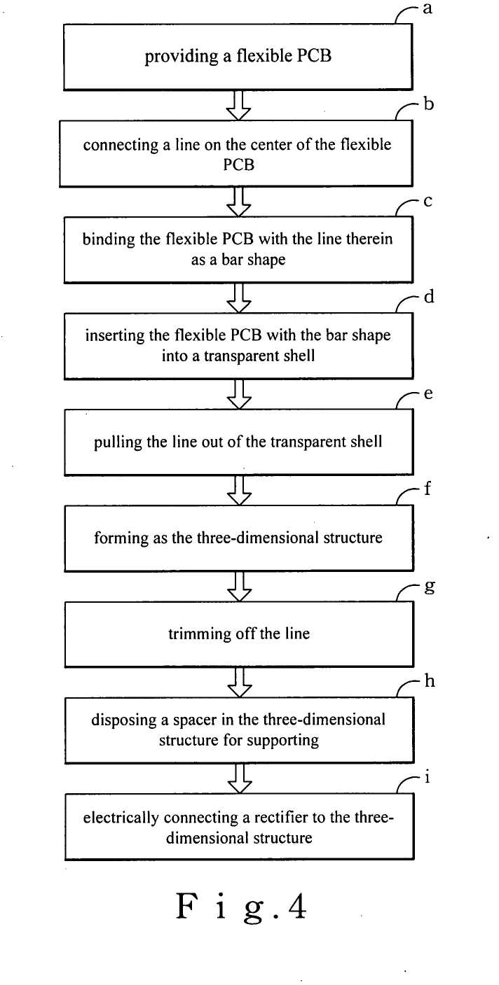

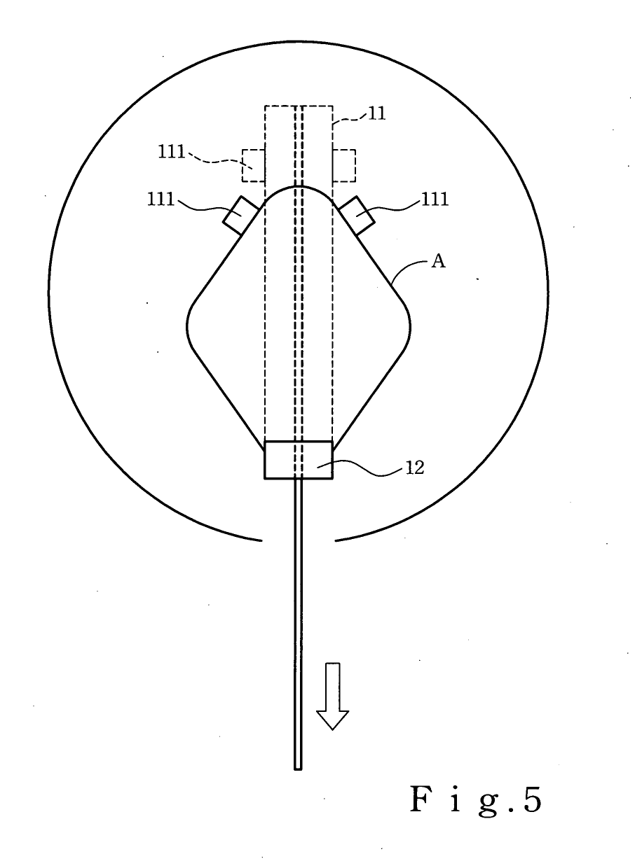

Please refer to FIG. 4 and FIG. 5 simultaneously, which illustrate steps of a method for forming the improved structure of the LED lamp of the present invention and a schematic view of a sequence of installing the improved structure into a transparent shell of the present invention. The steps includes: (a) providing the flexible PCB 11; (b) connecting a line Y on the center of the flexible PCB 11; (c) binding the flexible PCB 11 with the line Y therein as a bar shape, which is shown as a dotted line in FIG. 5; (d) inserting the flexible PCB 11 with the bar shape into a transparent shell X; (e) pulling the line Y out of the transparent shell X; (f) forming as the three-dimensional structure A; (g) trimming off the line Y; (h) disposing the spacer 114 in the three-dimensional structure for supporting, as shown in FIG. 2; and (i) electrically connecting the rectifier 12 to the three-dimensional structure; wherein the figure of the flexible PCB is shaped as the figures of “*”, that is, the figure of the flexible PCB is not limited by above figure and can be other wheel-spoke shaped of figures, which are able to form several types of three-dimensional structures, such as sphere, cube, rectangular solid, polygon solid, etc., the rectifier can be used as soldering pins for the three-dimensional structure, the improved structure further comprises a plurality of electric components and conductive member, which are resistors and solder pads mounted on the flexible PCB and the flexible PCB 11 has the tier of LEDs 111 thereon. The step (h) is applied only on larger bulb sizes and no spacers are used, the whole spoke-shaped flexible PCB is held with the top center and the bottom soldering points. For smaller bulb sizes, spacers are used to extend the center portion of the globe-shaped structure.

From the movements of the step (e) pulling the line Y out of the transparent shell X; to the step (f) forming as the three-dimensional structure A, it is similar to the movement of opening an umbrella, so that the flexible PCB 11 with the bar shape can be opened. On the other hand, the transparent shell X is as the shell of a traditional light bulb. Hence, the present invention can still have the traditional shape, but with a new generation of emitting device.

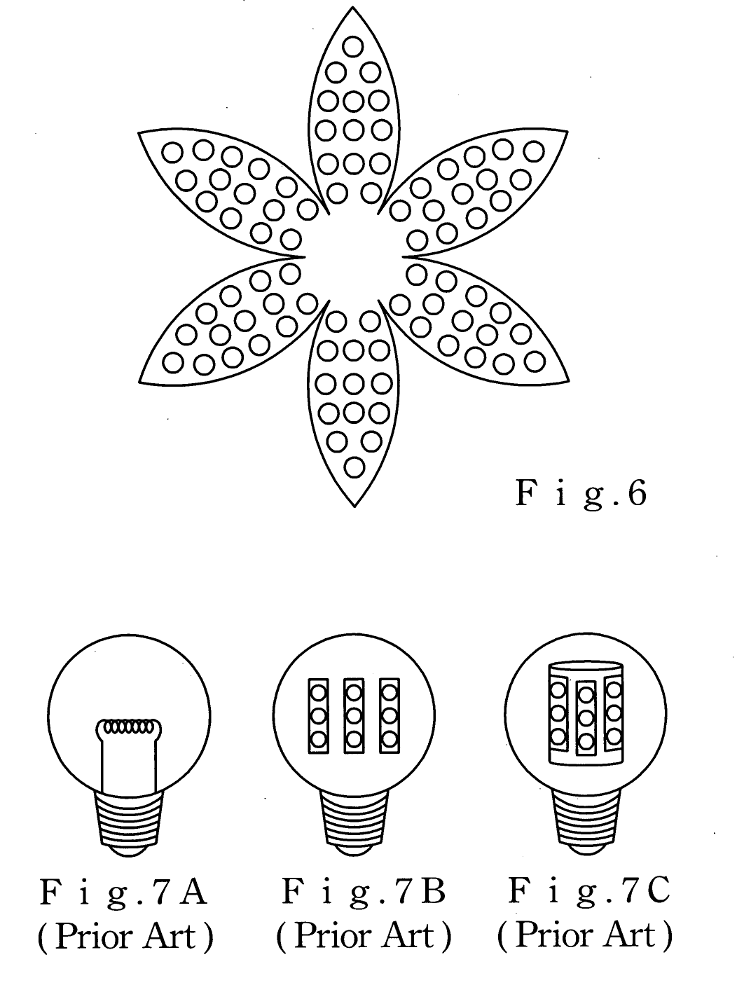

With reference to FIG. 6, which is a schematic exploded view of a multi-tier LED flexible PCB of a second preferred embodiment of the present invention. The embodiment is applied to a higher power LED light and to replace the higher power light bulb in prior arts.

The present invention discloses the advantages listed below:
1. The structure is easily made due to that of firstly mounting some electric components on the flexible PCB and then folding the flexible PCB to form a three-dimensional structure.
2. The present invention adopts LEDs as lighting components in order to offer longer product life and save power.
3. The present invention replaces the filament in any traditional incandescent light bulbs.
4. The present invention projects light in a spherical pattern identical to traditional incandescent light bulb.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An improved structure for an LED lamp, comprising:
a flexible PCB, which is wheel-spoke shaped to form a three-dimensional structure and has at least one tier of LEDs mounted thereon, the LEDs being electrically connected to the printed circuits of the flexible PCB; and
an electrical mounting member, which is disposed on the end of the three-dimensional structure and electrically connected to the three-dimensional structure.

2. The improved structure for the LED lamp according to claim 1, wherein the figure of the flexible PCB is shaped as the symbol of “*”.

3. The improved structure for the LED lamp according to claim 1, wherein the figure of the flexible PCB is shaped as the symbol of “+”.

4. The improved structure for the LED lamp according to claim 1, wherein the electrical mounting member is selected from the group of a rectifier and soldering pins.

5. The improved structure for the LED lamp according to claim 4, wherein the rectifier is a bridge rectifier.

6. The improved structure for the LED lamp according to claim 1 further comprising a plurality of electrical components and conductive member, which are resistors and solder pads mounted on the flexible PCB.

7. The improved structure for the LED lamp according to claim 1 further comprising at least one support member, which is inside the improved structure for retaining the improved structure.

8. The improved structure for the LED lamp according to claim 7, wherein the support member is a spacer.

9. A method for forming an improved structure of an LED lamp, comprising the steps of:
(1) providing a flexible PCB, which is wheel-spoke shaped to form a three-dimensional structure and has a least one tier of LEDs mounted thereon;
(2) fabricating the flexible PCB to form the three-dimensional structure; and
(3) electrically connecting an electrical mounting member to the three-dimensional structure.

10. The method for forming the improved structure of the LED lamp according to claim 9 wherein the figure of the flexible PCB is shaped as the symbol of “*”.

11. The method for forming the improved structure of the LED lamp according to claim 9, wherein the figure of the flexible PCB is shaped as the symbol of “+”.

12. The method for forming the improved structure of the LED lamp according to claim 9, wherein the step (2) further comprises the steps of:
(21) connecting a line on the center of the flexible PCB;
(22) binding the flexible PCB with the line therein as a bar shape;
(23) inserting the flexible PCB with the bar shape into a transparent shell;
(24) pulling the line out of the transparent shell;
(25) forming as the three-dimensional structure; and
(26) trimming off the line.

13. The method for forming the improved structure of the LED lamp according to claim 9, wherein the electrical mounting member is selected from the group of a rectifier and soldering pins.

14. The method for forming the improved structure of the LED lamp according to claim 13, wherein the rectifier is a bridge rectifier.

15. The method for forming the improved structure the LED lamp according to claim 9, wherein the improved structure further comprises a plurality of electrical components and conductive member, which are resistors and solder pads mounted on the flexible PCB.

16. The method for forming the improved structure the LED lamp according to claim 12, a further step after the step (26) is:
(27) disposing a spacer in the three-dimensional structure for supporting.
